(19) United States
(12) Patent Application Publication
(10) Pub. No.: US 2022/0288946 A1
(43) Pub. Date: Sep. 15, 2022

(54) PRINTER PERFORMANCE LEVELS

(71) Applicant: HP SCITEX LTD., Netanya (IL)

(72) Inventors: Ziv Rotman, Netanya (IL); Semion Birger, Netanya (IL); Alex Veis, Netanya (IL)

(73) Assignee: HP SCITEX LTD., Netanya (IL)

(21) Appl. No.: 17/652,871

(22) Filed: Feb. 28, 2022

(30) Foreign Application Priority Data
Mar. 11, 2021 (EP) 21162158.6

(51) Int. Cl. B41J 2/21; B41J 29/393

(52) U.S. Cl. CPC B41J 2/2142; B41J 2/2139; B41J 29/393; B41J 2/2146

(57) ABSTRACT

In an example a method includes, by processing circuitry, acquiring a digital image of a printed output and receiving an indication of the performance level of a printer used to print the printed output. It may be determined if the performance level meets a predetermined standard. When the performance level does not meet the predetermined standard, an indication that the predetermined standard has not been met may be generated. The digital image may be displayed for inspection.

### BACKGROUND

In printing, print agents such as inks, toners, coatings and the like, may be applied to a substrate. Substrates may in principle comprise any material, for example comprising paper, card, plastics, fabrics or the like.

In some examples, the resulting printed output may be analyzed in order to identify potential or actual defects. In some examples, a human quality controller reviews the printed output to determine if the output is of an intended standard. In some examples, a printed substrate is scanned, and the captured digital image is compared to a reference image using image processing techniques. The reference image may for example comprise an image which formed the basis of a print instruction, or may comprise a digital version of a previously printed image which has been determined to meet certain criteria.

### BRIEF DESCRIPTION OF DRAWINGS

Non-limiting examples will now be described with reference to the accompanying drawings, in which:

FIG. 1 is a flowchart of an example method of determining if a printer performance level meets a predetermined standard;

FIG. 2 is a flowchart of an example method of determining a performance level of nozzles of a printer;

FIG. 3 is a flowchart of an example method of displaying a modified digital image;

FIG. 4 shows an example of a modified digital image;

FIG. 5 is a diagram of example apparatus;

FIG. 6 is a further example of an apparatus; and

FIG. 7 is an example of a machine-readable medium in association with a processor.

### DETAILED DESCRIPTION

When printing with printing apparatus (also referred to as ‘printers’ herein), print quality defects may occur. In some examples, these defects may be associated with defects in or on components of the print apparatus. For example, for inkjet or similar technologies, these defects may include streaks caused by misfiring or non-firing nozzles (generally termed ‘defective nozzles’ herein). For example, nozzles may become blocked or damaged during use. Other defects may be seen in other types of print apparatus.

Previous methods to tackle defects in printing have included manual inspection of printed sheets. In some such cases, images may be printed as part of a print run which can involve printing the same or similar images many times over (for example, printing newspapers, books or packaging). Images may be inspected periodically, in which case a fault may be present for some time before it is detected, with resulting wasted print materials. In other examples, human quality controllers may watch as a print apparatus produces printed outputs. While this may allow a fault to be detected sooner, it is a skilled task and utilizes dedicated human resource.

In other examples, a ‘master image’ (often referred to as a ‘golden image’) may be acquired and image processing techniques may be used to compare a printed output to this image. However, the processing resource used to analyze images in this way is significant and it is not always practical to analyze every image when printing is on going, particularly given the speed with which some print apparatus is capable of printing. In addition, such systems may be relatively complex to set up. For example, determining the threshold at which an image is determined to be defective may be a specialized task, and may be determined for each individual print job.

In some examples, a test pattern may be printed to assist in identifying defective print apparatus operations or components. Still further, print apparatus components may be monitored directly. For example, drop detection apparatus may be used to determine if a nozzle is dispensing print apparatus as intended. Further examples are discussed below. Such methods can assist a user in identifying defective components.

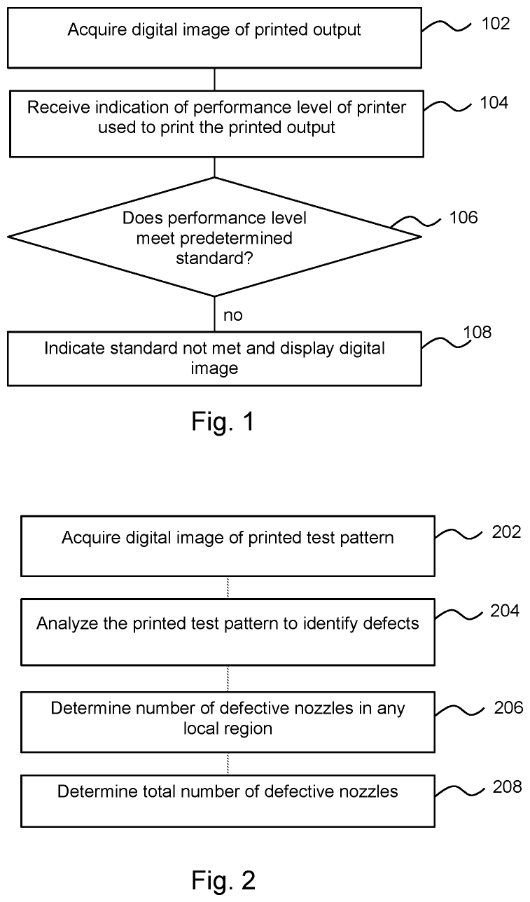

FIG. 1 is an example of a method, which may be a method for use in the field of detecting printing defects and/or a method for determining when an indication that a print apparatus performance level is not meeting a predetermined standard should be generated. The method may in some examples be a computer implemented method. In this example, the method is carried out by processing circuitry, which may comprise at least one processor.

In some examples, the method of FIG. 1 may be carried out ‘on-the-fly’, i.e. during a print run, to provide an operator with information about the print run while it is on-going.

Block 102 comprises acquiring a digital image of a printed output.

In some examples, the digital image may for example be acquired by scanning printed substrate sheets or continuous substrate web bearing a printed output, for example images, patterns, text or the like. The substrate may for example comprise paper, card, plastic, fabric or the like. For example, such digital images may be acquired by scanning apparatus or a digital camera, which may in some examples be operatively connected to the processing circuitry carrying out the method. In some examples, such processing circuitry may comprise a component of a print apparatus or scanning apparatus (and some apparatus for printing images may incorporate both print apparatus and scanning apparatus).

In some examples, the digital image may be acquired from a memory, which may be local or remote, and/or maybe received over a network, or the like.

In some examples, the digital image is acquired during a print run, which may be a print run of tens, hundreds or even thousands of printed outputs. The printed outputs may be intended to be substantially the same, or at least similar to one another (e.g. pages of text, or images having similar coloring). However, in other examples, the images may be different from one another. In some examples, a digital image is acquired for each printed output in such a print run, or periodically through the print run. For example, a digital image may be acquired for every Nth printed output, where N is an integer.

Block 104 comprises receiving an indication of a performance level of a printer used to print the printed output. The performance level may for example comprise an indication of the performance of at least one component of the printer.

In some examples, the printer may comprise one or more nozzles. For example, the printer may comprise an inkjet or bubble jet printer. In such examples, the indication of the performance level may for example comprise an indication of the performance level of at least one nozzle. For example, the performance level may be determined based on data derived from nozzle health monitoring apparatus, for example any or any combination of drop detection apparatus, temperature monitors, current monitors, voltage monitors, resistance monitors, an indication of an age of a nozzle (i.e. how long a nozzle has been in use), an indication of an idle period of a nozzle (as nozzles which have been unused for a period of time may be prone to defects), or the like. In some examples, performance level or ‘health’ of individual nozzles may be determined. A nozzle may for example be deemed to be defective if it fails to eject print agent, if it ejects print agent in an unintended direction and/or with an unintended time delay, and/or if it ejects print agent in a drop of an unintended size, or based on some other criteria or combination of criterion.

In some examples the printer may comprise one or more surfaces. For example, the printer may comprise an electrophotographic printer, for example a liquid electrophotographic printer or an electrophotographic printer which utilizes dry toner. In such examples, the indication of the performance level may for example comprise an indication of the performance level of a photoconductive surface on which an image may be formed, or another surface of such a printer via which images are transferred. For example, in some such apparatus, the image may be transferred from an imaging forming photoconductive surface to an ‘intermediate transfer member’ under pressure and/or electrostatic charges before being applied to a substrate. For example, the electronic properties and/or temperature of such surfaces may be monitored, the surfaces may be inspected optically, and/or the age of a surface may be determined. In some examples, defects or degradation in a local portion of a surface may be determined. These may be physical defects (such as changes to shape), defects such as dirt or debris on a surface, and/or may be performance defects, such as a reduced ability to hold an electrostatic charge. Alternatively or additionally, print agent delivery and/or drying apparatus and/or the effectiveness of image transfers may be considered.

In some examples, the indication of the performance level may comprise an indication derived from analysis of a printed test pattern. For example, deviations from an expected pattern may be indicative of a performance issue with at least one component of the printer. For example, as described in greater detail below, this may be used to detect a location of a defective nozzle and/or a position of a defective portion on a surface on which an image is formed or transferred in the case of an electrophotographic printer.

In some examples, one or more component of the printer, or the printer as a whole may be given a score based on its output and/or other indications of health. For example, in an inkjet printer, factors such as any or any combination of the age of the nozzle, how long the nozzle has remained unused, nozzle operating temperature, nozzle operating current/voltage/resistance and the like, may be combined to provide a ‘performance level score’ for a printhead/printheads of a print apparatus. In some examples, where there is an indication that neighboring nozzles may be defective, this may have a greater impact on the performance score than when well separated nozzles are deemed to be (at least potentially) defective. In other examples, a surface or some other component(s) of a printer may be scored based on similar characteristics. The score may be used to indicate the performance level.

In some examples in which the performance level comprises an indication of the number of defective nozzles, the indication of the number of defective nozzles may be indicative of the absolute number of defective nozzles of the print apparatus and/or of a print head. In some examples, an indication of the location of the nozzles which are deemed to be defective may also be provided. In some examples, the indication of the number of defective nozzles may be indicative of the number of defective nozzles in a localized region of a printhead, or the like. For example, it may be indicative of a group of defective nozzles, or of nozzles which are separated by less than a threshold separation. In some examples, the group may be a continuous group. In other examples, the indication of the number of defective nozzles may indicate if any group of N neighboring nozzles comprises M defective nozzles, where N and M are integers.

Block 106 comprises determining if the performance level meets a predetermined standard. For example, this may comprise determining whether a number of defective nozzles (which may for example be any or any combination of a number of defective nozzles in a localized region, a number of defective nozzles in a printhead, and/or a number of defective nozzles of the printer as a whole) is less than a predetermined maximum number of defective nozzles. In another example, it may comprise determining if some other printer component (e.g. an image forming or transfer surface of a printer) or printer operation (e.g. image transfer or image drying) is operating at an intended level.

If there is a determination that the performance level of the printer (or of at least one component thereof) does not meet the predetermined standard, the method proceeds to block 108, which comprises generating an indication that the performance level has not met the predetermined standard and displaying the digital image for inspection, for example by an operator.

The indication that the performance level has not met the predetermined standard may for example be a visual indication or alert, for example output via a display or with a light and/or audible alert, for example output via a speaker. In some examples, the indication that the predetermined standard is not met may be displayed with the digital image. For example, the digital image may be modified to comprise an indication. In other examples, display of the image may be conditional on the determination such that display of the image provides the indication. In some examples, the indication may be transmitted via a network or the like, for example to a remote location.

If the determination in block 106 is that the performance level does meet the predetermined standard (e.g., for an inkjet printer, the nozzles are generally performing at an acceptable level), then the indication is not output. In some examples, the digital image is not displayed for inspection in such a case, while in other examples, the image may be displayed. In some examples, the image is displayed without an indication if the determination in block 106 is that the predetermined standard has been met, and is displayed with the indication (for example, having been modified to include the indication) if it is determined that the standard has not been met. As set out below, the indication may in some examples indicate a likely or possible location of a printing defect.

In some examples, if the determination in block 106 is that the performance level does meet the predetermined standard (e.g. for an inkjet printer, the nozzles are generally performing at an acceptable level), a new image may be acquired, for example of a subsequent printed output in a print run. In other words, the method may loop back to block 102 (in some examples after or concurrently with displaying the image) and acquire a new digital image.

In some examples, after the indication is generated and the image is displayed, an inspection by an operator (or human quality controller) of the image may result in a user input that the image does not meet intended quality standards. This may for example result in a print run being interrupted and/or a prompt to service the printing apparatus.

In some examples, a print run may be resumed, for example using printing methods such as ‘defective nozzle compensation schemes’ to allow printing to continue while minimizing the visual impact of defective components. For example, in the case of defective nozzle(s) (which may be referred to as ‘missing nozzles’ in some examples), there may be more than one nozzle which could be used to eject print agent at a given location, or at least sufficiently close thereto. For example, a neighboring nozzle may be instructed to print a larger drop or second drop to compensate for the missing drop. In some examples there may be a plurality of printheads for a given colorant which pass over a region of a substrate. While an initial drop distribution scheme may assign a particular nozzle of a first printhead to print a particular drop of print agent, if that nozzle is deemed to be defective, a nozzle on a second printhead which passes over the same region may instead be assigned the task of issuing the drop of print agent. In still other examples, the colorant may be replaced by another colorant or colorant combination. For example, in a CMYK colorant system, black may be provided by the black ink, or may be ‘imitated’ with a combination of the other colorants. A print run may be paused to implement such a compensation scheme.

In examples where an operator determines that the image does meet intended quality standards, the operator may indicate that printing is to continue and/or the method may (automatically in some examples) loop back to block 102.

In some such examples, the predetermined standard for the performance level may then be altered. For example, a threshold number of defective nozzles may be increased such that a further indication will not be generated unless at least one additional nozzle or nozzles is determined to be defective. This may for example reflect the fact that the operator has determined that an image which is being printed repeatedly is not adversely affected by the indicated number of defective nozzles (or more generally, the performance level of the apparatus). Therefore, in some cases, there may be no need to repeatedly generate alerts in relation to images having this characteristic.

By alerting the user when displaying those images for which the performance level does not meet the predetermined standard with an associated indication, inspection of an image may be prompted when the likelihood of a defect within the image exceeds a threshold, and not otherwise, when it is less likely that there will be a print quality defect.

It may be noted that any given performance level may or may not be appropriate in a given circumstance. For example, a particular number of defective nozzles—be that in a localized group or over an entire printhead—may sometimes, but not always, result in image quality issues. For example, the human eye may tolerate more defective nozzles dispensing a lighter color than a darker color. In terms of a printing system which may comprise a four-colorant printing system made up of cyan, magenta, yellow and black (CMYK) colorants, it may be that an image quality issue associated with the darker colorants, for example black, is apparent to a user when just a few nozzles (for example, less than 10) are defective. However, the human eye may tolerate a larger number of defective yellow nozzles before a print quality issue arises. In addition, the impact of defective nozzles may depend on the content of the image being printed. If, for example, the image contains no or very little magenta, then a large number of magenta nozzles may be defective before image quality issues arise.

In addition, the degree to which image defects are tolerable may depend on an intended use of the image. For example, certain images are intended to be viewed at a distance and in such cases some print quality defects may be more tolerable. Other printed outputs are intended to convey quality. For example, packaging for an expensive item may generally be expected to be of a higher quality than packaging for a cheaper item. Thus, the number of defective nozzles which results in a print quality issue is somewhat subjective. In some examples, this may be reflected in the predetermined standard for the performance level. In other examples, it may be a human operator that determines whether a particular performance level is acceptable in a given circumstance based on their review.

By determining a performance level and presenting the image to an operator for inspection with an appropriate indication when the determined performance level does not meet the predetermined standard, an operator user may be motivated to review fewer images overall, but may still be able to determine in a timely manner whether a print run should continue or be interrupted. However, the operator may not continuously monitor every printed output of a print run, or otherwise risk a print run comprising a large number of printed outputs which contain a defect before the defect is detected.

FIG. 2 is an example of a method of carrying out block 104 of FIG. 1. In this example, the printed output comprises a printed test pattern. Any deviations from an expected pattern in the printed test pattern (e.g. voids or a deviation from an expected optical density) may be indicative of a defect of a component the printer used to print the printed output, or another performance issue. In some examples, the printed test pattern may be analyzed to identify a defective component. The printed test pattern may be printed by the printer used to print the printed output, and in some examples, the printed test pattern is part of the printed output. For example, such test patterns may be printed in a region of the substrate which it is intended will be discarded. For example, when packaging is printed, it may subsequently be shaped by cutting away portions of the substrate. Such regions of the substrate may bear, for example, indications of where cuts should be made, registration marks and the like. In examples herein, such a region may bear a test pattern. In one example, a test pattern may comprise a strip which runs substantially the full printable width of the substrate. At least one strip may be printed for each colorant. In examples in which the printer comprises nozzles, the strip may be printed by using a different nozzle for each of a plurality of portions along the length of the strip. Therefore, if there is an unprinted/misprinted area along the length of the strip, this may be associated with the nozzle that was intended to print that portion. In other words, the location of a defective nozzle may be determined based on the length along the strip of a void/misprint. In some examples, the test pattern may comprise a relatively small area of a printed output when compared to the printed output as a whole.

Block 202 comprises acquiring, by processing circuitry (which may be the same processing circuitry carrying out the method of FIG. 1), a digital image of the printed test pattern. This may be acquired directly (e.g. by scanning), from a memory, over a network or the like, or more generally in any way as described for the printed output above in relation to block 102. In some examples, the digital image of the printed test pattern is acquired as part of the printed output.

In block 204, the printed test pattern is analyzed to determine if it comprises any defects.

This may comprise comparing the digital image of the printed test pattern to a reference test pattern, for example on a pixel by pixel, or patch by patch, basis. In other examples, the analysis may be carried out according to some other predetermined criteria, such as an intended mattness of the image, or color consistency, or the like. In some examples, a void/misprinted region may be identified and used to determine defective components (e.g. defective nozzles) directly.

In some examples, identifying a defect in the printed pattern may be a binary analysis: a defect is either determined to be present or absent. In other examples, a degree of deficiency may be evaluated, i.e. a measure of the difference between the test pattern and the expected pattern. For example, a value indicative of a color may be measured and compared to an expected value. In some examples, a certainty level may be assigned, i.e. there is an x % probability that an image pixel or patch has not printed as intended. This allows for some uncertainty to be introduced for example to reflect that an apparent defect may be an error in image capture rather than in printing. In such examples, defect values (which may be binary or weighted by the degree of deficiency or certainty associated therewith) may be determined for each of a plurality of pixels. For example, this may comprise identifying defects which have at least a threshold value indicative of a printing deficiency (for example, defects associated with a value which is above a threshold defect/probability value may be considered).

It may be noted that analysis of a printed test pattern may be carried out using less processing resource than may be utilized when analyzing a full page of an image. Moreover, such test patterns may remain consistent even when the image content of a printed output may change between print jobs. Thus, setting up a specific analysis for each print job may be avoided in some examples.

In this example, in block 204, the test pattern is analyzed to determine if it is indicative of any defective nozzles. However, in other examples, other defective components/print operations may be identified through analysis of the test pattern.

Block 206 comprises determining the number of defective nozzles in any local region. In this example, the method comprises determining the number of defective nozzles in any group of N neighboring nozzles. The groups may be overlapping in the sense that a first group may comprise nozzles 1 to 5 whereas a second group may comprise nozzles 2 to 6 and so on (although in practice the groups may be of any size, and the size of the group may be configurable by a user). In another example, the method may comprise determining the number of neighboring nozzles in a continuous row which are defective.

In addition, block 208 comprises determining the absolute or total number of defective nozzles. Both of these numbers may be supplied as part of the indication of the performance level.

Block 106 of FIG. 1 may therefore comprise comparing more than one number which is indicative of a number of defective nozzles to a respective predetermined value. For example, if there are any groups of N nozzles which contain more than M defective nozzles, this may result in a determination that the performance level does not meet the predetermined standard. In such an example, the indication may be generated and the image displayed for inspection as set out in block 108. However, even if there are no groups of N nozzles which contain more than M defective nozzles, the total number of defective nozzles may be compared to a second predetermined value and, if this total number of defective nozzles exceeds that second predetermined value, it may result in a determination that the performance level does not meet the predetermined standard and the indication may be generated as set out in block 108.

In an example where continuous rows of defective nozzles are detected, the largest number of defective nozzles in a continuous row may be compared to a predetermined value and, if it exceeds that predetermined value, it may result in a determination that the performance level does not meet the predetermined standard, and the indication may be generated as set out in block 108.

In other words, in some examples the number of defective nozzles and/or their relative location may be considered in determining whether a number of defective nozzles is greater than a predetermined value, and thereby whether the performance level meets the predetermined standard.

In other examples, the performance level may be determined in some other way, for example based on a performance level score as set out above. Moreover, in other examples, other defects may be quantified to determine the extent thereof. For example, instead of determining a number of defective nozzles, the size of an area of an image forming/transfer surface of a printer which may be defective and/or the extent to which a surface has a reduced ability to hold a charge may be determined.

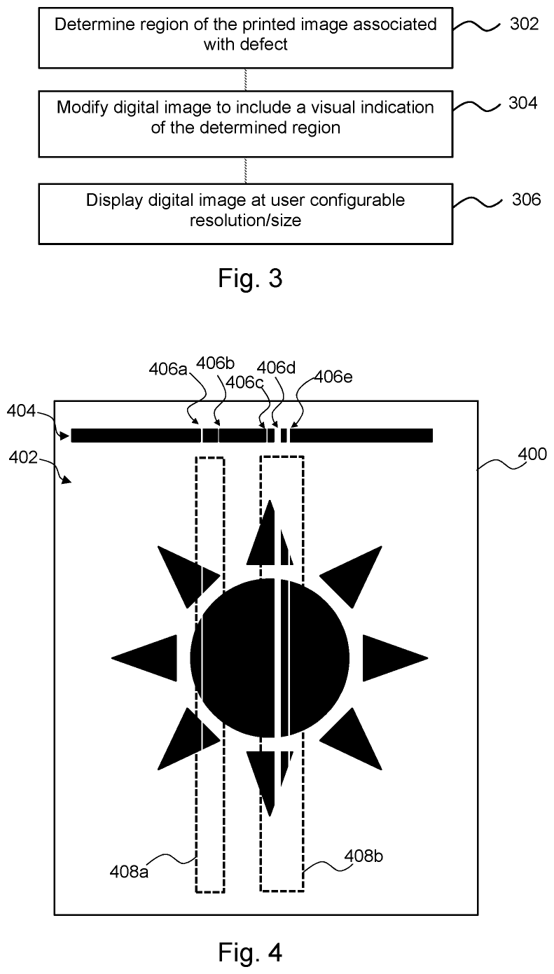

FIG. 3 is an example of a method of displaying a digital image comprising an indication that the performance level does not meet the predetermined standard. The method may be carried out by processing circuitry, which may be the same processing circuitry as described in relation to FIG. 1 and/or FIG. 2. In this example, the method comprises, in block 302, determining a region of the printed output which is associated with at least one defect. For example, this may be determined by analyzing a test pattern as described above in relation to FIG. 2. However, in other examples, component health apparatus, such as drop detection apparatus and/or electronic or temperature monitoring apparatus, may be used to indicate the position of potentially defective components or portions thereof. This may in turn be mapped to a region of the image which may be more likely to be impacted by the defective components. For example, the locations of defective nozzles may be determined, and/or a location of a defective component or region thereof may be mapped to a region of the printed output which is associated with at least one defect (i.e. which is more likely to be impacted by the defect in the component than another region in the printed output).

Block 304 comprises modifying the digital image to include a visual indication of the determined region. In some examples, this indication provides the indication that the performance level does not meet the predetermined standard as described with reference to block 108. For example, the region may be highlighted by providing a border or other visual indication of the region of interest. This may assist the operator in focusing on the region of the image which is likely to be impacted by the defect. This in turn guides the operator in their assessment of the image.

Block 306 comprises displaying the (modified) digital image on a display at a user configurable resolution and/or user configurable size. In this example, the image may be displayed initially at a first resolution which may be a full-page resolution, which allows the operator to view the image of the entire printed output at once, and is determined based on the screen size. However, in this example, the image resolution is user configurable, and the operator is able to ‘zoom’ into the image. For example, the operator may choose to zoom into the region of the image highlighted using the visual indication to perform a close inspection for defects.

Presenting an image which is scalable in terms of resolution and/or size therefore assists the operator in assessing the image.

FIG. 4 shows an example of a modified digital image 400 of a printed output, in this example produced by an inkjet printer. In this example, the printed output includes a printed image 402 and a test pattern 404. In this example, the test pattern 404 is a test strip. It will be appreciated that a monochrome image is shown in the Figure but in other examples at least one test strip may be provided for each colorant used. The test pattern 404 comprises a number of voids 406a-e, which may be mapped to individual missing nozzles and to groups of missing nozzles based on the placement of the void(s) along the strip. Each of these voids 406a-e is associated with a visual indication 408a, 408b of the region of the image in line therewith in a printing direction. In other words, each nozzle addresses a vertical strip of the printed output: the locations in which the voids are located are more likely to be associated with possible defects in the printed output. In this example, defective nozzles which are separated by less than a threshold number are grouped in a visual indication 408a, 408b, such that a new visual indication may be provided when defective nozzles are separated by more than a threshold nozzle count. In other examples, a visual indication may be generated for each defective nozzle, or each continuous group of defective nozzles, or in some other way. In this example, generation of the visual indication provides generation of an indication that the performance level does not meet the predetermined standard, and the scanned image is modified to include the visual indication prior to display.

In some printing techniques, there may be some redundancy in nozzles in that it is possible that a particular vertical strip can be addressed by more than one nozzle. As noted above, in some printing methods, various compensation schemes may be used to assign a given pixel of an image to a particular nozzle such that defective nozzles may not always result in a void/defect in an image. In this example, such compensation schemes are not used for printing the test pattern 404 but may be used when printing the image 402. Thus, a void in the test pattern may not always be associated with a visible defect in the printed output. In addition, as noted above, some image portions may be readily impacted by a defective nozzle whereas other image portions, by virtue of their content, may be impacted insignificantly in terms of the visual impression.

In this example, some of the larger groups of defective nozzles have resulted in clear defects within the image 404. The operator may therefore choose to interrupt a print run or, if the print quality is of an intended (albeit low) standard, the operator may instead allow the print run to continue and may indeed change the predetermined standard for the performance level. For example, where the performance level is compared to a value associated with the number of defective nozzles, the acceptable number of defective nozzles may be increased.

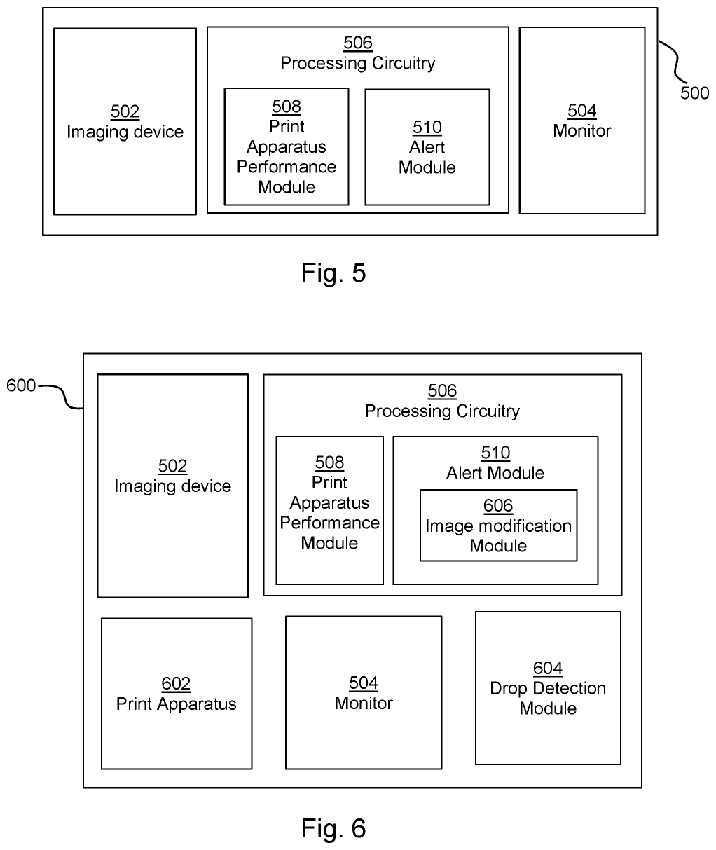

FIG. 5 is an example of an apparatus 500 comprising an imaging device 502, a monitor 504 and processing circuitry 506 comprising a print apparatus performance module 508 and an alert module 510.

The imaging device 502, in use of the apparatus 500, acquires a digital image of a printed output. In some examples, the imaging device 502 may acquire images of each printed output of a print run and/or may acquire images periodically during a print run. However, as set out above, these images may in some examples be conditionally modified based on a determination of the printing performance of the print apparatus used to print the image. In some examples, the imaging device 502 may comprise a scanner and/or a digital camera or the like. In other examples, the imaging device 502 may acquire the digital image from a memory or over a network or the like.

The print apparatus performance module 508, in use of the apparatus 500, determines if the print apparatus used in printing the printed output (or at least one component thereof) is operating below an intended performance level. For example, and as described above, this may comprise determining if nozzles (for example, a set of nozzles) are operating below the intended performance level. In some examples, this may comprise determining if a number of nozzles (which may be any or any combination of a number of nozzles in a local area of a printhead, an absolute number of nozzles of a printhead, an absolute number of nozzles of the print apparatus, or the like) is above a threshold. In some examples, it may be determined if other print apparatus components, such as any or any combination of image forming surfaces, image transfer surfaces, print agent supply systems, print agent drying systems and the like, are operating as intended.

In use of the apparatus 500, the monitor 504 displays the digital image. For example, the digital image may be displayed for inspection by an operator of the system to determine whether the printed output meets a quality threshold. The monitor 504 may comprise a display screen, and in some examples may be a touch sensitive display which is capable of directly receiving inputs, for example allowing an operator to control how an image is displayed and/or indicate if the print quality of the displayed image (i.e. the displayed digital version of the printed output) is acceptable or not acceptable. The monitor 504 may be capable of showing the image at a plurality of different sizes/resolutions.

When it is determined that the print apparatus (or at least one component thereof) is operating below the intended performance level, the alert module 510 generates an alert. The alert may be any indication that the performance level does not meet the intended level, for example comprising a visual alert, for example displayed on the monitor 504 and/or an auditory alert. In some examples, the alert may be sent to a remote location, for example over a network or the like. In some examples, generating the alert may comprise modifying the digital image. For example, the image may be modified to indicate that the print apparatus is operating below the intended performance level, and in some examples generating the alert may comprise modifying the digital image to indicate a region of the digital image of the printed output in which an image defect is more likely prior to display of the image, based on an output of the print apparatus performance module, as discussed above with reference to FIGS. 3 and 4.

In some examples, the processing circuitry 506 may carry out at least one block of FIG. 1, 2 or 3.

FIG. 6 is an example of an apparatus 600, which comprises the components of apparatus 500. The apparatus 600 further comprises a print apparatus 602 and print apparatus component health monitoring apparatus, which in this example comprises a drop detection module 604. In addition, in this example, the alert module 510 comprises an image modification module 606.

In this example the print apparatus 602 is an inkjet print apparatus comprising at least one printhead, the printhead comprising a plurality of nozzles. The print apparatus may be configured to eject ink from the nozzles in accordance with an image to be printed. For example, the inkjet print apparatus may comprise a thermal or Piezoelectric drop-on-demand or continuous inkjet printer. However, in other examples, the print apparatus may comprise another type of printer, for example an electrophotographic printer, a 3D printer (also referred to as additive manufacturing apparatus, which in some examples may print binding agents and/or fusing agents onto a layer of build material), a solid ink printer, a laser printer, an LED printer or the like.

In this example, the print apparatus 602 is to print an image on a substrate to provide the printed output and the imaging device 502 comprises a scanner to scan the printed output, and thereby acquire a digital image thereof.

In use of the apparatus 600, the drop detection module 604 detects drops of print agent printed by nozzles of the print apparatus 602 and determines if each nozzle is operating below its intended performance level. This information is used in turn by the print apparatus performance module 508 to determine whether the nozzles, as a whole, are operating below an intended performance level. As described above, this may comprise determining an absolute or a local number of nozzles which are operating below their intended performance level, and/or determining a performance level score.

Alternatively or additionally, in some examples, the imaging device 502 may acquire an image of a test pattern (which may be printed by the print apparatus 602) and the print apparatus performance module 508 may analyze the test pattern to determine if any print apparatus component is operating below its intended performance level. This information may be used by the print apparatus performance module 508 to determine whether the print apparatus, as a whole, are operating below its intended performance level. In this example, the number of defective nozzles may be determined.

In use of the apparatus 600, when the print apparatus performance module 508 determines that the print apparatus 602 is operating below its intended performance level (and not otherwise), the image modification module 606 is to modify the digital image to highlight a region of the image which is which is associated with at least one print apparatus component which is operating below the intended performance level (and may therefore be associated a relatively high likelihood of a printing defect). In this example in which the print apparatus 602 is an inkjet printer, the highlighted region may be associated with at least one nozzle operating below its intended performance level, for example as described above with reference to FIGS. 3 and 4. This provides an alert or indication that the print apparatus is operating below the intended performance level. In some examples, this indication may be provided in association with groups of nozzles within a localized area rather than for individual nozzles. In other examples, any region of an image which may be printed with a nozzle which is determined to be defective may be highlighted with a visional indication.

The modified image comprising the indication may be displayed on the monitor 504.

In some examples, the apparatus 500, 600 may accept a user input, for example to interrupt a print run and/or to zoom in or out on the image presented on the monitor 504.

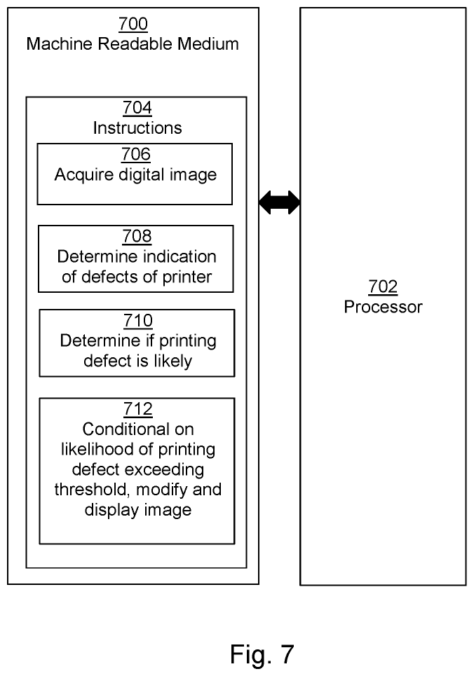

FIG. 7 is an example of a tangible, non-transitory, machine readable medium 700 in association with a processor 702. The machine readable medium 700 comprises (or stores) instructions 704 which, when executed by the processor 702, cause the processor 702 to carry out operations. The instructions 704 comprise instructions 706 which, when executed, cause the processor 702 to acquire a digital image of an image printed by a printer. For example, this may comprise controlling an image capture device such as a scanner or digital camera, and/or retrieving an image from a memory and/or over a network. In some examples, the digital image may comprise a printed output which may include a test pattern as described above.

The instructions 704 further comprise instructions 708 which, when executed by the processor 702, cause the processor 702 to determine an indication of defects of the printer. This may for example comprise analyzing a test pattern and/or receiving data from health (or performance) monitoring apparatus which is monitoring the health/performance of printer components such as nozzles, surfaces and the like.

The instructions 704 further comprise instructions 710 which, when executed by the processor 702, cause the processor 702 to determine if the indication of defects indicates a likelihood of a printing defect exceeding a predetermined threshold. For example, this may be determined when a local or absolute number of defective nozzles exceeds a threshold or when a performance level score falls below a threshold, as described above.

The instructions 704 further comprise instructions 712 which, when executed by the processor 702, cause the processor 702 to, conditional on the likelihood of a printing defect exceeding the predetermined threshold, modify the digital image to include a visual indication of an alert and to display the digital image on a display screen (for example a monitor) for inspection. However, unless the likelihood of a printing defect exceeds the predetermined threshold, the alert is not generated (whereas an image may or may not be displayed).

In some examples, the indication of defects of the printer comprises an indication of defective nozzles of the printer and further comprises an indication of the location of each defective nozzle and the instructions 708 to cause the processor to determine if the indication of defects indicates a likelihood of a printing defect exceeding a predetermined threshold comprises determining if a number of nozzles in a printhead, and/or if a number of nozzles in a local region of a printhead, are defective.

In some examples, the indication of defects of the printer comprises an indication of defective nozzles of the printer and further comprises an indication of the location of each defective nozzle and the instructions further comprise instructions to cause the processor to modify the digital image to indicate a portion thereof associated with a location of at least one defective nozzle. For example, this may provide a visional indication associated with a region of the page addressable by defective nozzle(s) as described in relation to FIGS. 3 and 4.

In some examples, the instructions may carry out at least one block of FIG. 1, 2 or 3. In some examples, the instructions may provide at least part of the processing circuitry 506.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus functional modules of the apparatus and devices (for example, the print apparatus performance module 508, alert module 510, drop detection module 604 and/or image modification module 606) may be implemented, at least in part, by a processor executing machine readable instructions stored in a memory, or a processor operating in accordance with instructions embedded in logic circuitry. The term ‘processor’ is to be interpreted broadly to include a CPU, processing unit, ASIC, logic unit, programmable gate array, etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing device(s), so that the computer or other programmable data processing device(s) perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising, by processing circuitry:
acquiring a digital image of a printed output;
receiving an indication of the performance level of a printer used to print the printed output;
determining if the performance level meets a predetermined standard and, when the performance level does not meet the predetermined standard, generating an indication that the predetermined standard has not been met; and
displaying the digital image for inspection.

2. A method according to claim 1 further comprising, by the processing circuitry:
determining a region of the printed output associated with a defect in a printer component;
wherein generating the indication that the predetermined standard has not been met comprises modifying the digital image to include a visual indication of the determined region and displaying the digital image comprises displaying the modified digital image.

3. A method according to claim 1 wherein the indication of the performance level comprises an indication of a number of defective nozzles.

4. A method according to claim 3 wherein the indication of the performance level comprises an indication of a number of defective nozzles in a localized region of a printhead.

5. A method according to claim 1 wherein receiving the indication of the performance level comprises:
acquiring a digital image of a printed test pattern,
determining any deviations from an expected pattern in the printed test pattern.

6. A method according to claim 1 wherein displaying the digital image comprises displaying the digital image at least one of a user configurable size and a user configurable resolution.

7. A method as claimed in claim 1 further comprising printing at least one substrate with an image and scanning the at least one printed substrate to acquire the digital image.

8. An apparatus comprising:
an imaging device to acquire a digital image of a printed output;
a monitor to display the digital image; and
processing circuitry comprising
a print apparatus performance module to determine if print apparatus used in printing the printed output is operating below an intended performance level; and
an alert module to generate an alert when it is determined that the print apparatus is operating below the intended performance level.

9. An apparatus as claimed in claim 8, further comprising a print apparatus to print an image on a substrate to provide the printed output.

10. An apparatus according to claim 9, wherein the apparatus comprises a drop detection module to detect drops of print agent printed by nozzles of the print apparatus and the print apparatus performance module is to determine if a nozzle is operating below its intended performance level based on an output of the drop detection module.

11. An apparatus according to claim 8 wherein the imaging device is to acquire an image of a print apparatus test pattern and the print apparatus performance module is to analyze the test pattern to determine if the print apparatus is operating below its intended performance level.

12. An apparatus according to claim 8 wherein the alert module comprises an image modification module, wherein the image modification module is to modify the digital image to indicate a region of the image which is associated with at least one print apparatus component which is operating below the intended performance level.

13. A machine-readable medium comprising instructions which, when executed by a processor, cause the processor to:
acquire a digital image of an image printed by a printer;
determine an indication of defects of the printer;
determine if the indication of defects indicates a likelihood of a printing defect exceeding a predetermined threshold; and
conditional on the likelihood of a printing defect exceeding the predetermined threshold:
modify the digital image to include a visual indication of an alert; and
display the modified digital image on a display screen for inspection.

14. A tangible machine readable medium according to claim 13, wherein the indication of defects of the printer comprises an indication of defective nozzles of the printer and further comprises an indication of the location of each defective nozzle and wherein the instructions to cause the processor to determine if the indication of defects indicates a likelihood of a printing defect exceeding a predetermined threshold comprises determining if a predetermined number of nozzles in a local region of a printhead are defective.

15. A tangible machine readable medium according to claim 13 wherein the indication of defects of the printer comprises an indication of defective nozzles of the printer and further comprises an indication of the location of each defective nozzle and wherein the instructions to cause the processor to modify the digital image further comprise instructions to indicate a portion of the digital image associated with a location of at least one defective nozzle.
